(19) United States
(12) Patent Application Publication
(10) Pub. No.: US 2002/0184138 A1
(43) Pub. Date: Dec. 5, 2002

(54) Systems and methods for trading electrical transmission rights

(76) Inventor: Seabron Adamson, Cambridge, MA (US)

Correspondence Address: FOLEY HOAG LLP, PATENT GROUP, WORLD TRADE CENTER WEST, 155 SEAPORT BOULEVARD, BOSTON, MA, 02110-2600, US

(21) Appl. No.: 10/034,294

(22) Filed: Dec. 21, 2001

Related U.S. Application Data
(60) Provisional application No. 60/258,145, filed on Dec. 22, 2000.

(51) Int. Cl. G06F 17/60

(52) U.S. Cl. 705/37

(57) ABSTRACT

A system and method for trading electrical transmission rights are provided. The system and method employ an exchange mechanism based on unequal quantity exchange rates between sets of transmission rights. The exchange encourages efficient trading between market participants. In addition, the system and method permits participants to trade only one or a few transmissions rather than a portfolio of rights.

### RELATED U.S. APPLICATION(S)

This application claims priority to U.S. Provisional Application Serial No. 60/258,145, filed Dec. 22, 2000, which application is hereby incorporated herein by reference.

### BACKGROUND ART

It has long been recognized that the loop flow effects of power on an interconnected network may pose special problems for the design of efficient trading mechanisms (Hogan, W., Contract Networks for Electric Power Transmission, Journal of Regulatory Economics, 4:211-242, 1992). One mechanism currently used for the design of a power market is based on the electricity spot pricing literature (Schweppe et al., Spot Pricing of Electricity, Norwell: Kluwer Academic, 1988). These locational marginal pricing (LMP) systems depend on centralized optimization of supply and demand bids to reach a productively efficient solution, and provide a price for many nodes. All trading in this form of market may be based on financial hedging contracts (Hogan, W., Contract Networks for Electric Power Transmission, Journal of Regulatory Economics, 4:211-242, 1992). However, this method is not without its drawbacks. This model requires a substantial amount of centralization of decision-making, which may be institutionally difficult or unacceptable. The system or exchange operator may need complete information on the supply and demand functions of all market participants. In addition, information costs for the central operator may be high.

More recently, flow-based systems have attracted increased attention as a potentially efficient method of trading that does not require centralized optimization (Chao et al., Flow-Based Transmission Rights and Congestion Management, Electricity Journal, Vol. 13, No. 8:38-58, 2000). This market form is based upon the economic analysis of Chao and Peck (Chao, H. and Peck, S., A Market Mechanism for Electric Power Transmission, Journal of Regulatory Economics, 10:25-59, 1996). Under a flow-based mechanism, the system operator may initially define and allocate a limited number of physical transmission rights to market participants, that reflect the maximum allowable power flows across lines, elements or transmission interfaces. Participants may acquire a portfolio of flow-based or flowgate rights in order to complete their point-to-point trades. It should be noted that trading in the Chao-Peck/flow-based framework may be from each node to other nodes in the network or to and from a defined “hub” node. A “flowgate” right may be defined across a single network element (e.g. a transmission line) or across a broader transmission interface, and thus represent a set of individual network elements. The “portfolio” of flow-based or flowgate rights required to make a trade from one point or node to any other is calculated from the power transfer distribution function (PTDF) or trading matrix. The trading in these Coasian flow-based transmission rights may produce a productively efficient outcome if all gains from trade are realized.

It should be noted that trading in point-to-point transmission rights, which may themselves be thought of as bundles of individual flow-based or Chao-Peck rights, may be efficiently conducted by an exchange or other market mechanism where trading is not done on a one-to-one basis. Trading of rights, either point-to-point rights or bundles of flow-based or flowgate rights, may be based on the ratio of PTDF matrix elements (for the point-to-point rights) for any binding constraints. Traders may buy and sell point-to-point transmission rights (or other bundles of individual flow-based or flowgate rights) through the exchange, instead of assembling the portfolio of rights through individual transactions.

The operator of a transmission market or exchange may also provide other information to market participants that would aid them in trading and decision-making. The operator might provide to each participant (or a sub-set of participants) the effective selling or purchase price of additional energy at the hub. The effective price for purchasing additional energy at a participant's location might be calculated as the cost of purchasing additional energy at the hub (which might in turn be calculated from the set of outstanding offers by other participants to sell energy at the hub) plus the cost of acquiring any incremental transmission rights necessary to schedule the transfer of energy from the hub to the participant's location. Similarly the effective price to be paid for supplying additional energy at a participant's location might be calculated as the price to be paid at the hub (which might in turn be calculated fro the set of outstanding offers by other participants to buy energy at the hub) plus the cost of acquiring any incremental transmission rights necessary to schedule the transfer of energy from the participant's location to the hub.

One complicating feature of flow-based trading on an electricity network is the potential for counterflows on certain elements. For example, a trade from one point on a power network to another may actually relieve congestion, by producing flows in the opposite direction. This may be represented in the flow-based or Chao-Peck framework as the creation of new flow-based or flowgate rights, where the impact of a trade on a potentially constrained flowgate is negative. Trades scheduled on the network may be treated as obligations, not options, to ensure that the final flows can be accommodated on the network where counterflows are produced (Ruff, L., Flowgates vs. FTRs, and Options vs. Obligations, Aug. 26, 2000).

The flow-based method of trading, while it does not require the degree of centralization in the system operator function as the LMP method, suffers some drawbacks.

The number of transmission rights that must be defined to account for all of the actual or possible (e.g. state-contingent) constraints on an actual network may be large and impractical (Hogan, W., Flowgate Rights and Wrongs, Aug. 20, 2000). Transaction and information costs for traders may be high, especially if the physical realities of the network in question require that many rights must be traded in order to reflect the actual constraints on power flows. Markets for rights may be illiquid or thinly traded, and therefore may make it difficult for the market mechanism to converge to an efficient result. Given the large number of individual flow-based trades that might be required, it may also be difficult for individual traders to make informed decisions about their production, consumption and marketing positions. Another mechanism may be required in order to make Chao-Peck pricing efficient and practical given real-world limitations on information flows, etc. (Stoft, S., Congestion Pricing with Fewer Prices Than Zones, Electricity Journal, pp. 23-31, May 1998).

Accordingly, there remains a need for an efficient market for trading transmission rights.

### SUMMARY OF THE INVENTION

The systems described herein may offer significant improvements over the existing methods of trading in transmission rights. First, it may not require the substantial degree of centralization required in the LMP model, and the central operator may require substantially less information about the supply and demand preferences of individual traders. Second, it may not require that traders and other market participants trade in many individual flow-based rights in order to complete a single transaction, with the possibility for significant informational and transaction costs. A market participant seeking to make a single point-to-point transaction may buy a single composite transmission right (e.g. a bundle of individual flow-based rights) simply, which might for example allow for power to flow from the location of a generating unit to a central hub, or from that hub to a load. Third, by allowing market participants to more easily calculate the total costs and benefits of conducting a transaction, market participants may be able to trade more easily and with lower costs.

### BRIEF DESCRIPTIONS OF THE DRAWINGS

FIG. 1 illustrates an electric network employing an embodiment of the system of the present invention.

FIG. 2 illustrates a graphical representation of transmission constraints and trade equilibrium associated with FIG. 1.

FIG. 3 illustrates exchange rate calculation at a specific point.

FIG. 4 illustrates the network in FIG. 1 with a change in constraints to the network.

FIG. 5 illustrates a graphical representation of transmission constraints and trade equilibrium associated with FIG. 4.

FIGS. 6-8 illustrate a flow chart on the implementation of the system in accordance with one embodiment of the present invention.

### DETAILED DESCRIPTION OF SPECIFIC EMBODIMENTS

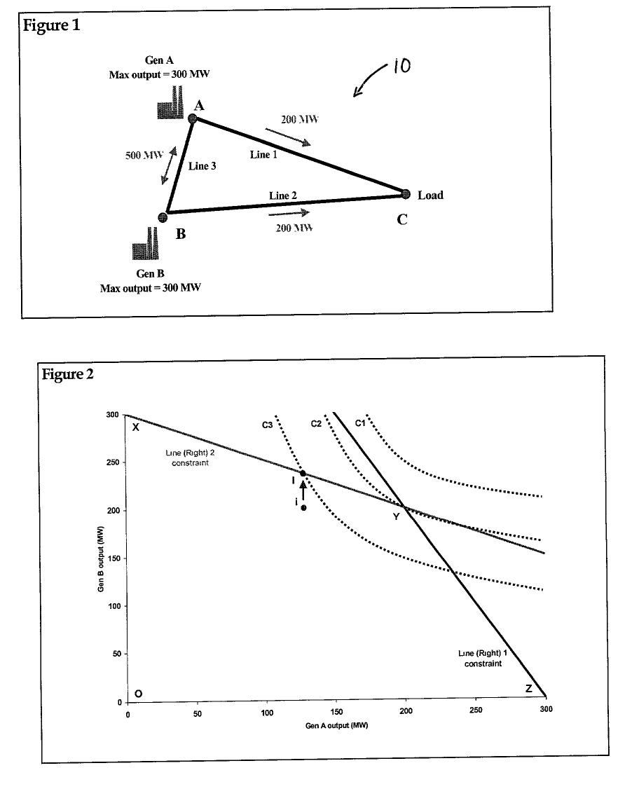

FIG. 1 illustrates, in accordance with one embodiment of the present invention, an example of an electric network or system 10, with two generators A and B located at nodes A and B respectively, and an electrical load at node C. Power flow capacity on each of lines 1, 2 and 3 is shown adjacent the arrows. It should be noted that in system 10, trading of three or more transmissions rights may be required in separate markets in order to reach a technically feasible and productively efficient solution.

Table 1 shows elements of a PTDF or trading matrix for the system 10, shown in FIG. 1. Due to the nature of electrical flows on a network, a transfer of power from node A to node C may result in the transfer of power along line 1 (from node A to node C) and along lines 3 and 2 (from node A to node B and from node B to node C). As such, a 100 MW transfer of power from node A (Gen A) to node C (Load) may require the market participant to acquire, for example, two thirds or about 66.67 MW of line 1 (i.e., flowgate 1) rights, and one third or about 33.33 MW of line 2 and line 3 (i.e., flowgates 2 and 3) rights. Two trades, therefore, may need to occur, from A to C and from B to C. The trades from A to C and from B to C are each represented by the headings across the top of each column in Table 1. The impact numbers on individual lines or flowgates are shown in the columns. It is easy to see that this trading process might be cumbersome and impractical if dozens or hundreds of rights must be traded to reflect the physical operations of a complex power or other network.

TABLE 1
Power Transfer Distribution Matrix (partial)

| | A-C | B-C |
|---|---|---|
| Line 1 (A-C) | 0.6667 | 0.3333 |
| Line 2 (B-C) | 0.3333 | 0.6667 |
| Line 3 (A-B) | 0.3333 | −0.3333 |

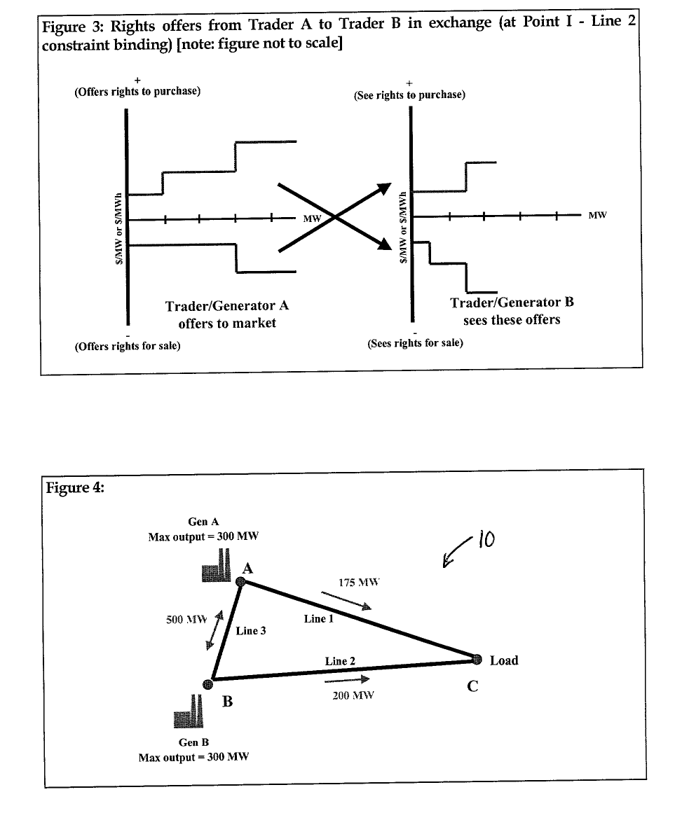

The combination of a (linear) power transfer distribution function, e.g. the fixed element matrix in Table 1, combined with fixed line or flowgate limits on system 10 produces (linear) “constraints” in the space defined by the output of Gen A and Gen B. These constraints are illustrated by lines XY and YZ in FIG. 2. The line XY can be determined by the maximum flow on Line 2 of FIG. 1. The line ZY, on the other hand, can be determined by the maximum flow on Line 1 of FIG. 1. For example, the output of Gen A times the corresponding PTDF element (0.6667, as shown in first column of Table 1) plus the output of Gen B times its corresponding PTDF element (0.3333) must be no greater than 200 MW. Three isocost curves (i.e., curves of constant production costs for an equivalent level of output) are also shown in FIG. 2, where the cost of C3>C2>C1. As illustrated, points on the isocost curves farther from origin O represent a lower total production cost.

Still referring to FIG. 2, assume that the initial allocation of trading rights on system 10 is technically feasible, such allocation can give Gen A and Gen B the outputs as shown at Point i. At Point i, no transmission constraint is binding on the system 10, so market participants can submit additional transactions to the system operator or exchange without creating any additional constraints on lines 1, 2 or 3 of system 10. At some point, however, transmission constraints do become binding, as represented by Point I in FIG. 2.

If the cost function is well behaved, then any efficient solution lies on the frontier defined by the space OXYZ in FIG. 2. Any cost-minimizing (i.e., welfare maximizing) trade may therefore involve tradeoffs between the output of Gen A and Gen B. However, as the slope of line XY illustrates, such tradeoffs are not made on a one-to-one basis. The slope (or inverse slope, depending on the convention) of line XY can, instead, be determined by the ratio of the power transfer distribution function (PTDF) elements for the constraint that is binding. In this situation, it is the line 2 constraint. The ratio of PTDF elements is therefore 0.6666/0.3333=2. In other words, if Gen A is to increase its output by 100 MW, then Gen B must drop its output by 50 MW, as its proportional impact on the constrained line 2 is twice as high.

This trading may be mutually beneficial, following the constraint line XY, until point Y is reached. Point Y represents the lowest cost isocost curve intersected by the frontier OXYZ and also represents the trading equilibrium. At this point further trading between Gen A and Gen B output could be permitted at a new exchange rate, which exchange rate may be defined by the inverse slope of line YZ, based on the ratio of PTDF elements where the line 1 constraint was binding.

A practical network may contain dozens, hundreds or even thousands of actual or possible constraints, not just the two constraints illustrated above in FIGS. 1 and 2. Nevertheless, trading could still work on the same basis. However, the frontier of possible inputs and outputs, instead of forming the simple polygon shown in FIG. 2 (OXYZ), may take the form of a multidimensional surface.

With the above in mind, the market-based trading method or exchange, in accordance with one embodiment of the present invention, might operate on the following basis. Market participants (e.g., generators, loads, traders or other participants) could each focus on trading one right. For example, this could be from a generator's location to a predefined hub (i.e., node), or from that hub to a load. Traders may need to focus only on buying and selling one right, not many, unless the traders operated from more than one location. Trading may likely be made in reference to a hub energy market, or alternatively trading in transmission rights could be integrated with energy trading as well.

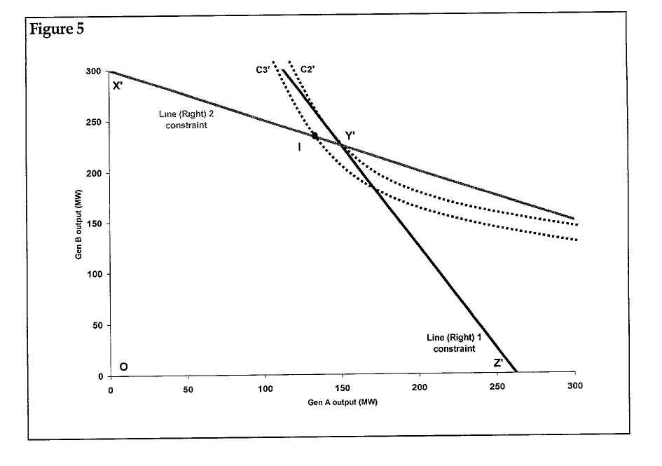

Offers to buy and sell rights could be made, and could be converted by the exchange operator into equivalent buy and sell offers at other locations, based on a quantity “exchange rate”. This exchange rate, as noted above, could be calculated for different participant pairs based on their locations (and hence their different PTDF matrix elements) for the currently binding constraints. The effect of the exchange could thus be to “translate” one quantity into another, as illustrated in FIG. 3.

FIG. 3 illustrates the exchange rate calculation at Point I for the system 10 shown in FIG. 2. On the left hand side of FIG. 3, Trader/Generator A could offer to buy and sell rights, for example, in this case, point-to-point rights from node A to hub (load) node C.

These rights could be shown as price-quantity blocks above and below the horizontal axis MW. Offers to purchase new rights are shown in this sign convention as being at positive $/MW price, while offers to sell rights are illustrated at a negative price. As described herein, the exchange rate may be used to convert these offers to equivalent node B to node C rights when the offers are made to Trader/Generator B. As noted previously in connection with FIG. 2, it was shown that the quantity exchange rate at Point I was 2:1. Thus, the quantities may be adjusted when they are presented to Trader/Generator B. For example, an offer to buy 100 MW of rights by Trader/Generator A may be adjusted to an offer to sell 50 MW of rights by Trader/Generator B. Conversely, an offer by Trader/Generator A to sell 50 MW of transmission rights might be adjusted to an offer for Trader/Generator B to purchase 25 MW of additional transmission rights.

The transmission rights market, such as that shown in system 10 of FIG. 1, may operate as a conventional continuous double auction (CDA) mechanism, or under other single or double-sided iterative auction structures. These mechanisms are widely discussed in the auction theory literature.

Under such a mechanism, the transmission rights market system or exchange could operate independently of the system operator, who may take transmission schedules (backed by the required rights) and produce a technically feasible schedule for operations. The system operator may produce the PTDF matrix and communicate to the exchange which constraints may be binding on the system at the time. The transmission exchange operator could then transmit data on new transmission rights positions (after trades had been made) back to the system operator, which could update its database on current flows. Trade through the transmission rights exchange may be conducted simultaneously with ordinary trading in flowgate or Chao-Peck rights. Further, there may be multiple exchanges or market makers operating on a competing basis.

It should be noted that, while FIG. 3 may generally show how an offer from one trader appears to another, FIG. 3 may not necessarily be to scale. The amount offers available and the prices at which the offers may be available may vary according to, for instance, the PTDF matrix elements inter-relating potentially trading parties.

In accordance with another embodiment of the present invention, transmission rights exchange or market operator may be integrated with the system operator who actually operates the transmission rights system. The exchange/operator may integrate the functions of accepting schedules with the trading in point-to-point transmission rights. In addition, market participants may submit trades, which can be accepted if no constraint were binding given the other rights outstanding or the trades previously submitted. It should be noted that holding transmission rights in many circumstances creates an obligation to produce energy, not just an option, as counterflows will be produced on some flowgates/lines that allow other trades to be accepted. A discussion of this aspect of transmission trading is provided in Ruff, L., Flowgates vs. FTRs, and Options vs. Obligations, Aug. 26, 2000. Once a transmission constraint has been reached, trading can occur as previously described. Energy trading at predefined hub(s) can be conducted independently of the transmission rights exchange or market.

In defining flow-based rights, it may be difficult and contentious to define a set of flow-based rights, in advance, that adequately captures the actual constraints on the transmission system, given the contingencies that may occur. For example, flowgate rights might be defined well in advance. However, on the day of operation, changes in transmission constraints (e.g., due to changes in network operations and line outages) may require that new constraints be added or that existing constraints be changed in order to reflect the actual state of the transmission system. If these flowgate rights have not been previously defined, then the trading equilibrium might produce a commitment schedule that may not be technically feasible, e.g. it might produce transmission flows that can breach the new constraint(s). A new flowgate may be defined, and the transmission rights may thereafter be auctioned or otherwise allocated. However, this may be cumbersome and costly. Moreover, as the operating hour approaches, there could be less and less time available to conduct such changes to the number and quantities of flowgate rights.

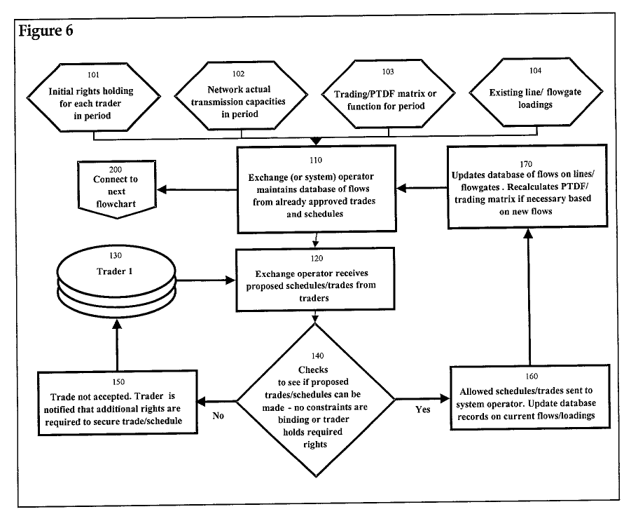

The system 10 described herein, in accordance with one embodiment of the invention, can mitigate these problems. Assuming that the initial allocation of rights is still technically feasible (after considering the new constraint), then an efficient solution may still be found, with no process needed for allocating and trading “new” flowgate rights. This is illustrated in FIG. 4.

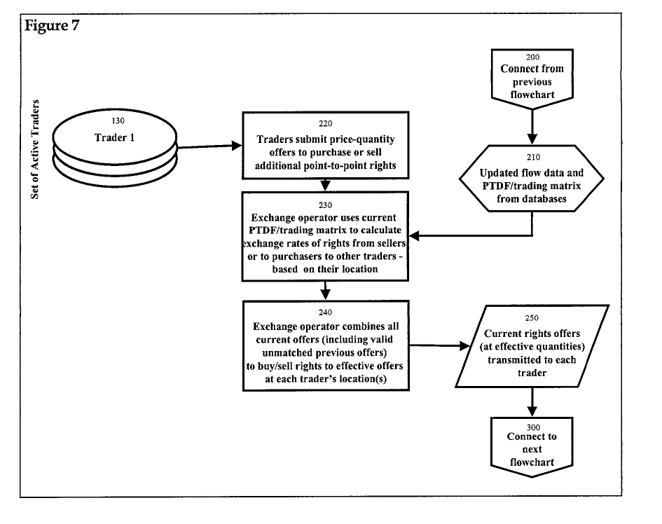

In FIG. 4, a change in the transmission system 10 is illustrated, which now requires that flows on line 1 be constrained to 175 MW, and not 200 MW as in FIG. 1. The constraint produces a change in line 1 constraint, which constraint is illustrated as line Y′Z′in FIG. 5. Looking now at FIG. 5, assuming that the starting allocation is at Point I, the initial trading between Trader/Generator A's rights (node A to node C in FIG. 4) and Trader/Generator B's rights (node B to node C in FIG. 4) may continue to be on a 2:1 quantity basis, reflecting the fact that the line 2 constraint remains binding. However, the new trading equilibrium is now at Y′, not the original Y in FIG. 2, reflecting that the line 1 constraint has now moved in towards the origin O. The trading equilibrium therefore touches a new isocost curve C2′, which curve represents a higher cost than the original equilibrium.

This aspect of the system 10 represents a significant practical advantage over existing flow-based methods for transmission congestion trading. New rights may not necessarily have to be created as transmission constraints change, as long as the initial allocation remains feasible. If the initial rights allocation were not feasible, in light of the changes in constraints or changes to the PTDF matrix caused by unexpected contingencies, various rights allocations methods may be used. In particular, all rights may be scaled downwards until the constraint set can be met. Alternatively, those market participants who have not paid for priority may see their rights reduced. Under any of these circumstances, once a feasible starting rights allocation position has been created, the operation of the system 10 may lead to an efficient result.

Operation of system 10, in accordance with one embodiment of the invention, is now provided. The system 10 provides a transmission rights exchange that may operate partially independently of the system operator controlling the network. The role of the transmission rights exchange operator in system 10 may, in an embodiment, be limited to operating the exchange market for point-to-point transmission rights bundles, and may not include the operation of a “hub” energy market or other parts of the electricity market.

In general, the system 10 permits, through a network, the receipt of offers to buy and sell point-to-point transmission rights from market participants. Subsequently, a determination may be made whether schedules of offers submitted to the exchange or system operator do not require any additional rights to be obtained. Thereafter, quantity exchange rates between pairs of transmission rights may be calculated. The calculated exchange rates may be used to make offers to buy and sell rights to other market participants to and from their previously defined locations on the system 10. It should be noted that the exchange rates can be made on the basis of the ratios of their impact on the binding transmission constraints, as defined in a power transfer distribution function in functional or matrix form, such that all binding constraints continue to be satisfied if the trades between market participants are made. The system 10 can then represent offers, including of price and quantity blocks where the quantities have been adjusted using the exchange rate mechanism described above, to buy and sell transmission rights made by each participant to other participants. Submitted orders from participants for buying and/or selling rights in response to the offers made by other market participants can be processed by the system 10. Any trades to buy and sell rights may be matched, based on the quantities and prices of transmission rights submitted by market participants that are currently valid on the system 10. For any trades made, the system 10 can record the trades, and update the set of rights held by each market participant as well as the trades made for settlement purposes.

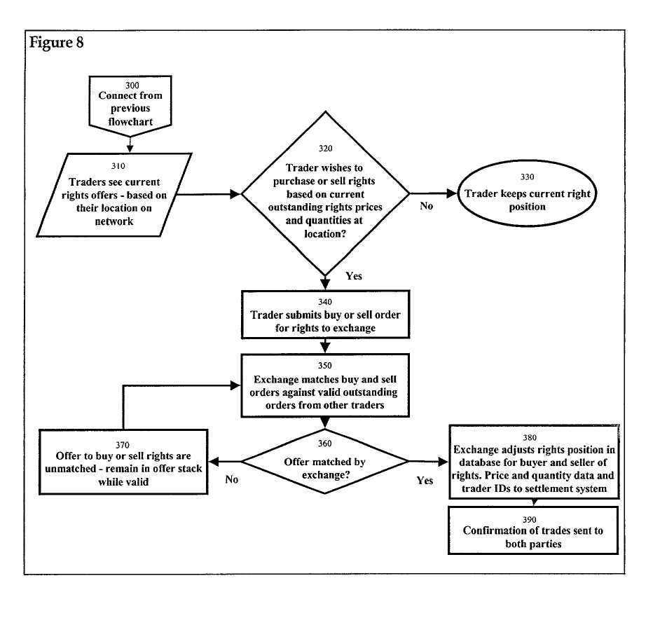

With particular reference to FIGS. 6-8, system 10, in accordance with one embodiment, may be implemented as follows. As is often the case, there are initial inputs that may be determined exogenously, by the system operator or other processes. In 101, there exists an initial set of transmission rights (e.g., point-to-point) that have already been allocated to market participants for the period. This allocation may have been made by a regulatory agency, based on grandfathered contracts, or by some other process. In 102, the system operator may have determined the actual transfer capability of the system 10 for a particular period, based on the physical state of the system 10 and other parameters. It may be assumed, for the purpose of this discussion, that the initial allocation of rights is technically feasible. In 103, the system operator may provide a power transfer distribution matrix or function that reflects the initial state of the system in the trading period. In 104, the system operator may provide data on other already expected flows or line reservations, such as those from external contracts, for certain reserve requirements.

The transmission rights exchange operator, or alternatively, the system operator, may maintain a database in 110 that gives current expected flow on each line or flowgate, and the maximum flows permitted to meet system constraints. A set of market participants may be represented in 130. These may be generators, loads, marketers, other users or participants of the transmission system 10. In 120, the market participants may submit proposed trades or schedules, for instance, from their location to a designated hub or other location, to the exchange operator, or alternatively, to the system operator. The proposed trades or schedules may not be “approved” until they are checked in 140 to determine whether a) the proposed schedule will cause a flow on any constrained line (based on the PTDF matrix or function, as described previously), or b) the proposing market participant holds a set of required point-to-point transmission rights to make the trade (in conjunction with any other trades previously submitted).

In 150, a market participant whose proposed schedule/trade does not meet the criteria set forth in 140 may have the proposed trade rejected. In order to meet the criteria, the market participant may need to buy additional transmission rights through the exchange, as described below, or buy additional point-to-point or flowgate rights through, for instance, a bilateral market or other means, in some implementations. A market participant whose proposed schedule/trade does meet the criteria set forth in 140 will have the proposed trade accepted. With an accepted trade in 160, the operator may determine that no transmission constraints will be affected or that the market participant holds the required rights. The system operator may subsequently be notified to include the trade in its list of accepted transactions, and the operator updates its database of rights held, thus the expected transmission flows, as described in 110.

In 170, the exchange operator (or the system operator) may update the PTDF/trading matrix if necessary, to account for the additional line loadings on the system 10. The PTDF or trading matrix, or other equations or function describing the impact of proposed trades on potentially constrainable elements of the network or sections of the network, may be updated during the trading process to reflect changes in the state of the transmission system or other contingencies. A resulting, new PTDF or trading matrix may be created to use for calculating exchange ratios between transmission rights for potential and actual trades. In some instances, the PTDF matrix may not be completely constant, but may depend on system loadings. In such a case, the actual power transfer function that might be used includes the marginal loadings for an additional trade, and not the average one as in the linear case.

It should be noted that although the PTDF or trading matrix or function may be non-constant or nonlinear, it may still be a function of the loading of the system 10, the trades already made, or other transactions that have been previously scheduled on the system 10. In such case, flows may be determined on individual network elements given the existing schedules trades or loadings, based on the database of existing trades, or estimated from state information. In addition, the PTDF may be evaluated, using as input parameters, the values of line loadings and other state information as described above. A marginal PTDF matrix or function may also be evaluated, if the variations are significant, at various possible line loadings that may occur, given the set of possible trades. Any resulting marginal PTDF may be used to calculate an exchange rate between possible trades on the network.

Furthermore, in response to an introduction of new transmission constraints that reflect changes in the state of the transmission system or other contingencies, new flow constraints, as determined by the system operator or other parties externally to the system, may be inputted into the set of constraints used in calculating the exchange ratios between sets of transmission rights.

The preceding process may proceed continuously or near-continuously in the trading period, and simultaneously with the operation of the actual transmission rights exchange itself. The operation of the latter is illustrated in FIG. 7. In 210, various databases may have been updated to reflect all accepted schedules up to present. Market participants who wish to buy or sell their point-to-point transmission rights may make offers do so in 220. Market participants may submit price and quantity pairs for blocks of their transmission rights, either to purchase additional rights or to sell unneeded rights. Typically, these rights may be defined as being from their location to a hub point for generators, or from hub point to a delivery point for loads.

In 230, the transmission rights exchange operator may define or calculate the “exchange rate” between the various point-to-point transmission rights being traded. The calculation may be done using the ratio of the PTDF elements (or evaluated functions) for the rights (e.g., rights bundles), for the constraint that may currently be binding given the current loading of the network 10, as recorded in the database in 110. Where more than one constraint may currently be binding, the exchange rate between the sets of rights may be set on the more binding constraint. In this manner, swapping transmission rights between the two parties at the quantity exchange rate, if agreed, may not breach any transmission constraint. The exchange rate calculation may be made using the PTDF matrix ratio from the location of the rights seller or buyer to all other traders at their respective locations. In addition, the quantity exchange rate may be established by first calculating, using the PTDF or trading matrix, the impact of a trade between each pair of market participants, on each of the potentially binding constraints. It should be noted that the quantity exchange rate will be set at the most restrictive exchange ratio thus calculated. The establishment of the quantity exchange rate may be finalized when under each possible trade, as presented by the exchange operator to other market participants, it can be ensured that the set of transmission constraints (whether state-contingent or not) will continue to be met if the trade is consummated.

240, the rights exchange operator may combine all of the offers to buy or sell rights into a set of purchase or sale curves for each trader. This may be done by using the exchange rate mechanism to convert all outstanding sales or purchase offers, which are offers to buy or sell transmission rights from a given location, to effective quantities for other traders. In one embodiment, the system 10 permits the receipt of offers to buy and sell point-to-point transmission rights from market participants and blocks of energy at a trading hub or other point. Subsequently, a determination may be made whether schedules of offers submitted to the exchange or system operator do not require any additional rights to be obtained. Thereafter, quantity exchange rates between pairs of transmission and energy offers may be calculated. It should be noted that the exchange rates are made on the basis of the ratios of their impact on the binding transmission constraints, as defined in a power transfer distribution function in functional or matrix form, such that all binding constraints continue to be satisfied if the trades between market participants are made. The system 10 can represent offers, including price and quantity block where the quantities have been adjusted using the exchange rate mechanism described above, to buy and sell transmission blocks made by each participant to other participants.

On the supply side, the system 10 calculates for some or all participants, on a per MW or per MWh basis, the potential cost of acquiring differing levels of incremental transmission rights necessary for supplying energy at their location and having the energy delivered to the hub or any other specified point. The system 10 can also calculate, from the set of outstanding offers to buy energy at the hub, the current demand schedule, which demand schedule may be expressed as a set of price-quantity blocks, for energy at the hub. In addition, for some or all of the participants, the effective price to be paid for additional energy generated at their location can be provided on a “netback basis”. The effective price may be calculated from the outstanding offers to purchase energy at the hub, plus the incremental costs of acquiring sufficient transmission rights to schedule energy transfers to the hub from the participant's defined supply location.

On the purchasing side, the system 10 calculates for some or all participants, on a per MW or per MWh basis, the potential cost of acquiring differing levels of incremental transmission rights necessary for purchasing energy at the hub and having the energy delivered to their specified location. The system 10 can also calculate, from the set of outstanding offers to sell energy at the hub, the current supply schedule, which supply schedule may be expressed as a set of price-quantity blocks, for energy at the hub. In addition, for some or all of the participants, the effective price to be paid for additional energy received at their location can be provided on a “netback basis”. The effective price may be calculated from the outstanding offers to supply energy at the hub, plus the incremental costs of acquiring sufficient transmission rights to schedule energy transfers to the hub from the participant's defined supply location.

Subsequent to step 240, the resulting conversion of outstanding sales and purchase offers to effective quantities for other traders/participants could be a set of incremental and decremental rights offer curves from the perspective of each trader/participant, as illustrated in FIG. 3. These individualized offers may then be transmitted to each trader/participant in 250.

It should be appreciated that the incremental cost of acquiring additional transmission rights from the hub to the participant's location for the purpose of calculating the effective price to be paid for additional energy purchased may be made without reference to the net transmission rights position of the participant (e.g. the set of rights held by the participant and not used for scheduling other transactions). In one embodiment, the incremental transmission right acquisition cost may be based upon the cost of acquiring transmission rights from other participants at the prevailing prices.

The incremental cost of acquiring additional transmission rights from the hub to the participant's location for the purpose of calculating the effective price to be paid for additional energy purchased may, alternatively, be made with reference to the net transmission rights position of the participant (e.g. the set of rights held by the participant and not used for scheduling other transactions). In one embodiment, the incremental transmission right acquisition cost may be zero if the needed rights for additional purchases of energy were already held by the participants and were not used for other sales or purchase transactions.

On the other hand, the incremental cost of acquiring additional transmission rights to the hub from the participant's location for the purpose of calculating the effective price to be paid for additional energy supplied might be made without reference to the net transmission rights position of the participant (e.g. the set of rights held by the participant and not used for scheduling other transactions). In one embodiment, the incremental transmission right acquisition cost may be based upon the cost of acquiring transmission rights from other participants at the prevailing prices.

The incremental cost of acquiring additional transmission rights to the hub from the participant's location for the purpose of calculating the effective price to be paid for additional energy supplied may, alternatively, be made with reference to the net transmission rights position of the participant (e.g. the set of rights held by the participant and not used for scheduling other transactions). In one embodiment, the incremental transmission right acquisition cost may be zero if the needed rights for additional sales of energy were already held by the participants and were not used for other sales or purchase transactions.

In certain scenarios, additional supply or demand of energy at a participant's location may generate counterflows on constrained or potentially constrained transmission lines on the system 10. The potential for counterflows may be determined from a current PTDF matrix and a set of currently binding transmission constraints, as determined by the set of transactions and trades already made on the network. Where counterflows may be generated on a constrained or potentially constrained line, a trader submitting such a schedule may receive additional rights on constrained or potentially constrained lines. These potential or actual counterflow rights, which when bundled together, have the same mathematical form as a point-to-point transmission right as may normally be traded. Moreover, where counterflows might be in a transaction, the value of such counterflows may be subtracted from the incremental cost of acquiring additional transmission rights for the purpose of calculating the effective price of energy at a location.

Turning to FIG. 8, once the effect prices for supplying and purchasing energy have been determined, submitted orders from participants for buying and/or selling rights in response to the offers made by other participants can be processed by the system 10. Specifically, in 310 each market participant may see the set of price and quantity blocks of additional rights, at his or her location, as transmitted by the exchange operator. In 320, the market participant may decide whether he or she wishes to sell or purchase any additional transmission rights based on the prices and quantities offered by the exchange operator. If the market participant decides to forego selling or purchasing, then in 330 the market participant may maintain his or her existing position. If the market participant decides to sell or purchase, then in 340 the market participant may submit an order to buy or sell transmission rights to the exchange operator.

In 350, the transmission rights exchange operator may attempt to match the market participant's order against the set of outstanding valid buy and sell orders. Trades to purchase and sell blocks can be matched, based on the quantities and prices of energy and transmission blocks submitted by market participants that are currently valid on the system 10. If the offer could be matched by the exchange with an outstanding offer to sell (given the prevailing exchange rates between the various rights), then the transaction may be cleared in 360. If the offer to buy and sell rights cannot be matched by the exchange, as shown in 370, then the offer may remain valid for some period (depending on the exact exchange rules), and could be used to match future bids.

For any trades made, the system 10 can record the trades, and update the set of rights held by each market participant, the energy blocks bought and sold at the hub or other points, and the trades made for settlement purposes. In this case, the transmission rights exchange operator may adjust its database to reflect the new rights position of both buyer and seller. Price and quantity data, along with trader identities, may be forwarded to the settlement system.

It should be appreciated that in the event the system 10 is congested or prone to congestion, the system 10 may nevertheless permit, in accordance with one embodiment, a way for simultaneously trading in transmission rights and energy at specific nodes or hubs.

While the invention has been described in connection with the specific embodiments thereof, it will be understood that it is capable of further modification. Furthermore, this application is intended to cover any variations, uses, or adaptations of the invention, including such departures from the present disclosure as come within known or customary practice in the art to which the invention pertains, and as fall within the scope of the appended claims.

What is claimed is:

1. A method for trading electrical transmission rights, the method comprising:
receiving offers to buy and sell point-to-point transmission rights on a network from market participants;
calculating quantity exchange rates between pairs of offers to buy and sell transmission rights for subsequent representation to other market participants to and from their defined locations on the network, the quantity exchange rates being calculated on a basis of the ratios of their impact on binding transmission constraints, such that substantially all binding constraints on the network can be satisfied when trading occurs; and
matching trades to buy and sell transmission rights based on the offers to buy and sell transmission rights submitted by market participants that are currently valid on the system.

2. A method as set forth in claim 1, wherein, in the step of calculating, the ratios of impact on binding transmission constraints are defined by a power transfer distribution function (PTDF) in functional or matrix form.

3. A method as set forth in claim 1, wherein, in the step of calculating, when multiple transmission constraints are simultaneously binding on the network, the quantity exchange rates can be established by:
determining, using a PTDF or trading matrix, impact of a trade between each pair of offers to buy and sell on each of the potentially binding constraints; and
ensuring that under each possible trade the transmission constraints can continue to be met when a trade is carried out.

4. A method as set forth in claim 3, wherein the step of determining includes
updating the PTDF or trading matrix, during trading, to reflect changes in the state of the network or other contigencies; and
creating a new PTDF or trading matrix for use in calculating exchange rates between transmission rights for possible and actual trades.

5. A method as set forth in claim 3, wherein the PTDF or trading matrix is non-constant or non-linear, such that constraints on transmission can be determined on individual network elements in view of existing scheduled trades or loadings or estimated from state information.

6. A method as set forth in claim 5, wherein constraints on transmission is determined based on a database of existing trades.

7. A method as set forth in claim 5, further including:
evaluating the PTDF, using as parameters, values of line loadings and state information;
obtaining a marginal PTDF matrix or function at various line loadings in view of possible trades; and
calculating an exchange rate between possible trades on the network using the marginal PTDF matrix or function.

8. A method as set forth in claim 1, further comprising representing the offers to buy and sell transmission rights made by each participant to other participants, the representing offers including prices and quantities adjusted based on the calculated exchange rates.

9. A method as set forth in claim 1, wherein in the step of matching, the matching of trades to buy and sell transmission rights is based on the adjusted quantities and prices of transmission rights.

10. A method as set forth in claim 1, wherein the step of matching includes processing orders to buy and sell transmission rights submitted from the participants, which orders are in response to the offers made by other participants.

11. A method as set forth in claim 1, further including recording trades made.

12. A method as set forth in claim 11, wherein the step of recording includes updating set of rights held by each market participant and the trades made for settlement purposes.

13. A method as set forth in claim 1, further including limiting trades in transmission rights to at least one right, rather than providing a portfolio of rights, so as to permit electrical transmission to be transferred from a location to or from a defined hub or node.

14. A method as set forth in claim 1, further including accounting for new transmission constraints, in response to an introduction of new transmission constraints that reflect changes in the transmission systems or other contingencies, in a set of existing constraints used in calculating the exchange rates between offers to buy and sell transmission rights.

15. A method for simultaneously trading transmission rights and energy on a network, the method comprising:
receiving, from market participants, offers to buy and sell point-to-point transmission rights on the network and blocks of energy at a trading hub or other point on the network;
calculating quantity exchange rates between offers to buy and sell transmission rights and corresponding offers to buy and sell blocks of energy for subsequent representation to other market participants to and from their defined locations on the network, the quantity exchange rates being calculated on a basis of ratios of their impact on binding transmission constraints, such that substantially all binding constraints on the network can be satisfied when trading occurs;
determining a potential cost of acquiring incremental transmission rights for supplying energy at a participant's location and having the energy delivered to the hub or other points on the network, and a potential cost of acquiring incremental transmission rights for purchasing energy at the hub and having the energy delivered to a location;
providing an effective price to be paid for additional energy generated at a location and an effective price to be paid for additional energy received at another location; and
matching trades to buy and sell transmission rights and blocks of energy based on the offers to buy and sell transmission rights and blocks of energy submitted by market participants currently valid on the network.

16. A method as set forth in claim 15, wherein, in the step of calculating, the ratios of impact on binding transmission constraints are defined by a power transfer distribution function in functional or matrix form.

17. A method as set forth in claim 15, wherein the step of calculating includes computing, from the offers to buy energy at the hub, a demand schedule.

18. A method as set forth in claim 15, wherein the step of calculating includes computing, from the offers to sell energy at the hub, a supply schedule.

19. A method as set forth in claim 15, wherein, in the step of determining, the effective price to be paid for additional energy generated includes, offers to purchase energy at the hub, and the incremental costs of acquiring transmission rights for delivery of energy to the hub from a defined location.

20. A method as set forth in claim 15, wherein, in the step of determining, the effective price to be paid for additional energy received includes offers to supply energy at the hub and the incremental costs of acquiring transmission rights for delivery of energy to the hub from a defined location.

21. A method as set forth in claim 15, wherein, in the step of determining, the cost of acquiring incremental transmission rights to the hub from a participant's location for the purpose of calculating the effective price to be paid for additional energy supplied includes the cost of acquiring transmission rights from other participants at prevailing prices.

22. A method as set forth in claim 15, wherein, in the step of determining, the cost of acquiring incremental transmission rights to the hub from a participant's location for the purpose of calculating the effective price to be paid for additional energy supplied is zero if all of the needed rights for additional sales of energy were already held by that participants and were not used for other sales or purchase transactions.

23. A method as set forth in claim 15, wherein, in the step of determining, the cost of acquiring incremental transmission rights from the hub to a participant's location for the purpose of calculating the effective price to be paid for additional energy purchased includes the cost of acquiring transmission rights from other participants at prevailing prices.

24. A method as set forth in claim 15, wherein, in the step of determining, the cost of acquiring incremental transmission rights from the hub to a participant's location for the purpose of calculating the effective price to be paid for additional energy purchased is zero if all of the needed rights for additional purchases of energy were already held by the participants and were not used for other sales or purchase transactions.

25. A method as set forth in claim 15, wherein the step of determining includes assessing a potential for generating a counterflow on a constrained or potentially constrained transmission line on the network.

26. A method as set forth in claim 25, wherein the potential for generating a counterflow can be determined from a PTDF matrix and a set of binding transmission constraints.

27. A method as set forth in claim 25, wherein the step of determining further includes providing a participant generating a counterflow with additional rights on a constrained or potentially constrained transmission line on the network.

28. A method as set forth in claim 25, wherein the step of determining further includes subtracting a value of the counterflow from the cost of acquiring incremental rights for the purpose of calculating the effective price of energy at a location.

29. A method as set forth in claim 15, wherein, in the step of matching, the matching of trades to buy and sell transmission rights and blocks of energy is based on the adjusted quantities and prices of transmission rights and blocks of energy.

30. A method as set forth in claim 15, wherein the step of matching includes processing orders to buy and sell transmission rights and blocks of energy submitted from the participants, which orders are in response to the offers made by other participants.

31. A method as set forth in claim 15, further comprising representing the offers to buy and sell transmission rights and blocks of energy made by each participant to other participants, the representing offers including prices and quantities adjusted based on the calculated exchange rates.

32. A method as set forth in claim 15, further including recording trades made.

33. A method as set forth in claim 32, wherein the step of recording includes updating set of rights held by each market participant and the trades made for settlement purposes.
